(19) United States
(12) Patent Application Publication
(10) Pub. No.: US 2021/0123870 A1
(43) Pub. Date: Apr. 29, 2021

(54) ADVANCED DIAGNOSTICS, ASSEMBLY AND SERVICE OF A HIGH VOLTAGE BATTERY USING IMAGE PROFILES

(71) Applicant: BYTON NORTH AMERICA CORPORATION, Santa Clara, CA (US)

(72) Inventor: Pankaj Mahajan, West Bloomfield, MI (US)

(21) Appl. No.: 16/663,336

(22) Filed: Oct. 24, 2019

(51) Int. Cl. G01N 21/88; H01M 10/48; G05B 19/402; G06T 7/00; G08B 21/18

(52) U.S. Cl. CPC G01N 21/8851; H01M 10/482; G05B 19/402; G06T 7/001; G06T 2207/10048; H01M 2220/20; G01N 2021/8887; G05B 2219/2621; G06T 2207/30164; G08B 21/185

(57) ABSTRACT

Embodiments are disclosed to diagnose and/or assembly a battery pack for a vehicle based on imaging techniques. For one embodiment, a system captures one or more image profiles of the battery pack, where the battery pack comprises a plurality of battery cell modules. The system retrieves one or more image profiles based on an identifier of the battery pack, where the one or more image profiles was previously captured for a battery pack as a reference. The system identifies abnormalities for the captured images in comparison with the reference. The system analyzes for abnormalities to identify any malfunctioning components in the battery pack.

### FIELD

The disclosed embodiments relate generally to vehicle diagnostics systems and in particular, but not exclusively, to advanced diagnostics, assembly, and service of a high voltage battery using one or more assembly, thermal or electromagnetic image profiles.

### BACKGROUND

Assembling a high voltage battery pack (or battery pack) for electric vehicles (EVs) is complex and may vary widely by manufacturer and vehicle models. However, most battery packs incorporate a combination of smaller and simple mechanical and electrical components which perform their own basic functions but collectively work together to function as a single battery. Typically, a battery pack incorporates many discrete cell modules connected in series and parallel to achieve the total voltage and current requirements of the pack. Battery packs for EVs can contain several hundreds of individual (prismatic or cylindrical) cells. Large stack of cells can be grouped into smaller stacks (or cell modules) to assist in manufacturing and assembly.

Each cell module can be coupled together by voltage bus bars or wires to complete an electrical path for a current flow. The battery pack and/or cell modules can also include temperature and current monitoring mechanisms, and other devices.

However, assembly, testing, and diagnostics of a high voltage battery pack is very complex. Furthermore, individual battery cells or cell modules may fail, become problematic, or reach the end of their useful lives before, during, or just after assembly.

### SUMMARY

Embodiments are disclosed to diagnose (i.e., to determine a root cause and to resolve a problem) and/or to assemble a high voltage battery pack for a vehicle based on reference imaging techniques. Images can be obtained from High Resolution (1) RGB colored pictures (2) Thermal Images (3) Electromagnetic or Radio Frequency Spectrums profiles, etc. According to a first aspect, a system captures one or more image profiles (e.g., one or more images and/or data related to, or derived from, the images) of a battery pack, where the battery pack comprises a plurality of battery cell modules. The system retrieves one or more image profiles based on an identifier of the battery pack, where the one or more image profiles or related data, was previously captured for a battery pack (e.g., the same or similar having a similar battery pack layout, vehicle make, vehicle model) to be used as a reference. The system identifies abnormalities for the captured image profiles in comparison with the reference The system analyzes for abnormalities to identify any malfunctioning components in the battery pack.

According to a second aspect, a system assembles a battery pack, where the battery pack includes a number of battery cell modules. The system captures one or more image profiles of the battery pack by an image capturing device. The system identifies for any discrepancies between the one or more image profiles of the battery pack and image profiles, or related data, of one or more battery assemblies previously captured. If identified, the system indicates that a discrepancy exists for the assembled battery pack. In one embodiment, when an abnormality/discrepancy is identified, the system further stops the assembly line and notifies an assembly technician to allow the technician to fix the abnormality/discrepancy before completing the assembly of the battery pack, where the battery pack is to be assembled in a vehicle.

### BRIEF DESCRIPTION OF THE DRAWINGS

The appended drawings illustrate examples and, therefore, are exemplary embodiments, and not to be considered limiting in scope.

FIG. 1 is a block diagram of an exemplary system architecture for one or more battery diagnostic systems and a server;

FIG. 2 is block diagram of one embodiment of a battery diagnostic system;

FIG. 3 is a RGB image of one embodiment of a motor vehicle battery pack;

FIG. 4A is a thermal image of one embodiment of a motor vehicle battery pack;

FIG. 4B is a thermal image of one embodiment of a motor vehicle battery pack with a problematic cell module;

FIG. 5 is a side view of one embodiment of an assembly/service bench setup;

FIG. 6 is a flow diagram of one embodiment of a method; and

FIG. 7 is a flow diagram of one embodiment of a method.

### DETAILED DESCRIPTION

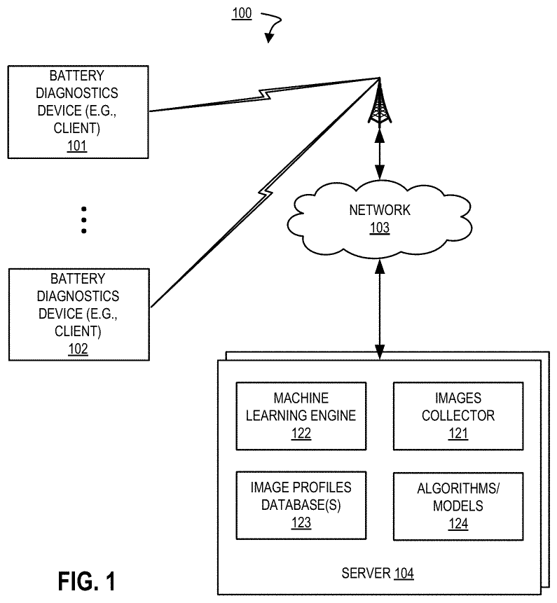

FIG. 1 is a block diagram of an exemplary system architecture for one or more battery diagnostic devices and a server. Referring to FIG. 1, system configuration 100 includes, but is not limited to, one or more battery diagnostic devices 101-102 communicatively coupled to data processing server 104 over network 103. Battery diagnostic devices 101-102 can diagnostic a battery pack of a vehicle based on an image profile of the battery pack. Battery diagnostic devices 101-102 may be any type of computing devices such as a microcontroller, a personal computer (e.g., desktops, laptops, and tablets), a “thin” client, a personal digital assistant (PDA), a Web enabled appliance, a Smartwatch, or a mobile phone (e.g., Smartphone), etc. Battery diagnostic devices 101-102 may be equipped with one or more imaging sensors to capture the image profile, e.g., one or more images. Each of devices 101-102 may be an independent device or a part of a larger system. For one embodiment, battery diagnostic devices 101-102 may be other servers.

For one embodiment, devices 101-102 can be a part of a system at an assembly plant for battery packs, a vehicle service center, a dealership, repair shop, or garage, or any place where a battery pack can be serviced/assembled. For one embodiment, one or more imaging sensors of devices 101-102 can be installed at a fixed location in a ceiling portion of an assembly plant or repair shop/garage, or attached to a fixed frame of a testbed that has a planar view of the components of a battery pack when the battery pack is being assembled. For one embodiment, devices 101-102 can be a mobile device which a user can take an image of the battery pack.

Network 103 may be any type of networks such as a local area network (LAN), a wide area network (WAN) such as the Internet, or a combination thereof, wired or wireless. The communication between client devices 101-102, data processing server 104 over network 103 can be secured, e.g., via TLS/SSL.

Data processing server 104 may be any kind of servers or a cluster of servers, such as Web or cloud servers, application servers, backend servers, or a combination thereof. Server 104 can include an interface to allow a client such as battery diagnostic devices 101-102 to access image database(s) 123 and/or algorithms/models 124 provided by server 104. Server 104 may be configured as a part of software-as-a-service (SaaS) or platform-as-a-service (PaaS) system over the cloud, which may be a private cloud, public cloud, or a hybrid cloud. The interface may include a Web interface, an application programming interface (API), and/or a command line interface (CLI).

For one embodiment, server 104 includes images collector 121, machine learning engine 122, image profiles database(s) 123, and algorithms/models 124. Images collector 121 can collect battery pack information and battery pack images for a number of vehicles. The battery pack images for each battery pack can be identified by a unique identifier.

Based on image profiles database(s) 123, machine learning engine 122 can generate or trains a set of rules, algorithms, and/or predictive models 124 to assembly and/or diagnose battery packs using images. For one embodiment, algorithms/models 124 may include machine learning or AI models to assess a health of a battery pack using thermal and/or RGB images of the battery pack. Image profiles and/or algorithms/models 124 can be uploaded to battery diagnostic devices 101-102 to be utilized by devices 101-102 in real-time.

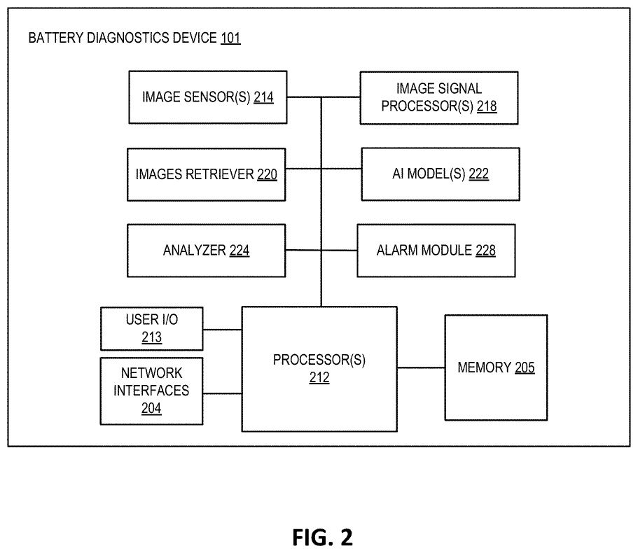

FIG. 2 is block diagram of one embodiment of a battery diagnostic device. Referring to FIG. 2, for one embodiment, battery diagnostic device 101 includes one or more processor(s) 212, memory 205, user I/O 213, and network interfaces 204. User I/O 213 may include any types of input or output device(s). Input device(s) may include a mouse, a touch pad, a touch sensitive screen (which may be integrated with a display device), a pointer device such as a stylus, and/or a keyboard (e.g., physical keyboard or a virtual keyboard displayed as part of a touch sensitive screen). For example, input device(s) may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

User I/O 213 may include a visual/audio device. An audio device may include a speaker and/or a microphone to facilitate voice-enabled functions, such as voice recognition, voice replication, digital recording, and/or telephony functions. A visual device can be a display monitor screen. Other 10 devices may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof.

For one embodiment, battery diagnostic device 101 includes image sensors 214, image signal processor 218, image retriever 220, AI model(s) 222, analyzer 224, and alarm module 228. Image sensors 214 can include one or more sets of sensors to capture red-green-blue (stereo or mono) color images and/or thermal images. For one embodiment, image sensors 214 can include any types of imaging sensors such as charged coupled device (CCD), infrared/thermal/electromagnetic image sensors, complementary metal-oxide semiconductor (CMOS) sensors, etc. Image signal processor(s) (ISP) 218 can be a specialized digital signal processor used for image processing. ISP(s) 218 can receive an image or picture from any one sensor for image processing. AI model(s) 222 can apply an AI model to an image or picture from any one sensor to infer a probability of an abnormality or discrepancy. Analyzer 224 can analyze for potential faulty or problematic component(s) based on an abnormality or discrepancy. Alarm module 228 can trigger an alarm to notify an operator of an abnormality or discrepancy. For one embodiment, alarm module 228 can halt an assembly line for an operator to inspect a battery pack. For another embodiment, alarm module 228 can further indicate visually or audibly a highlight in the image(s) which cell module or component(s) for an operator/technician to narrow down the inspection of the battery pack.

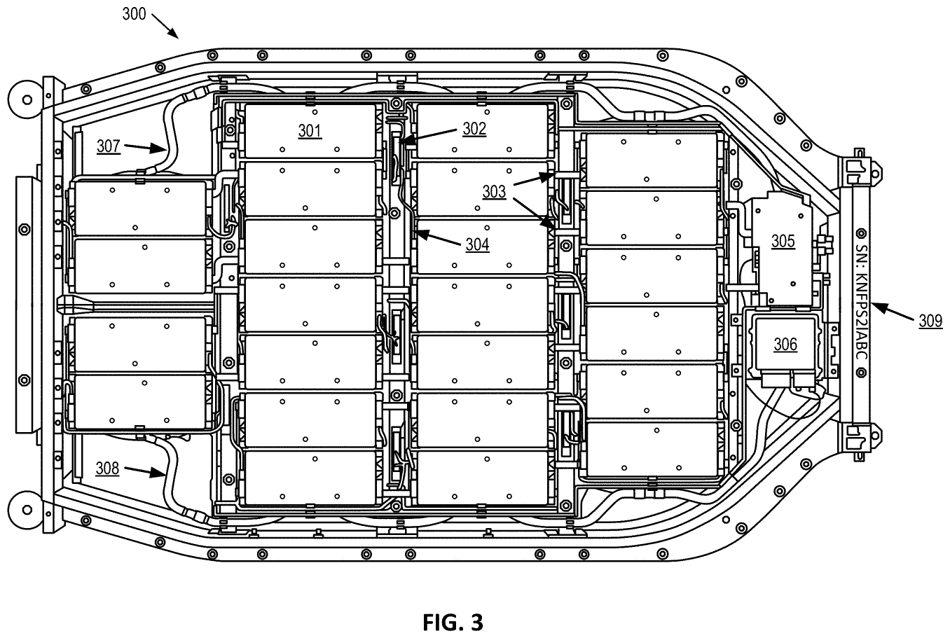

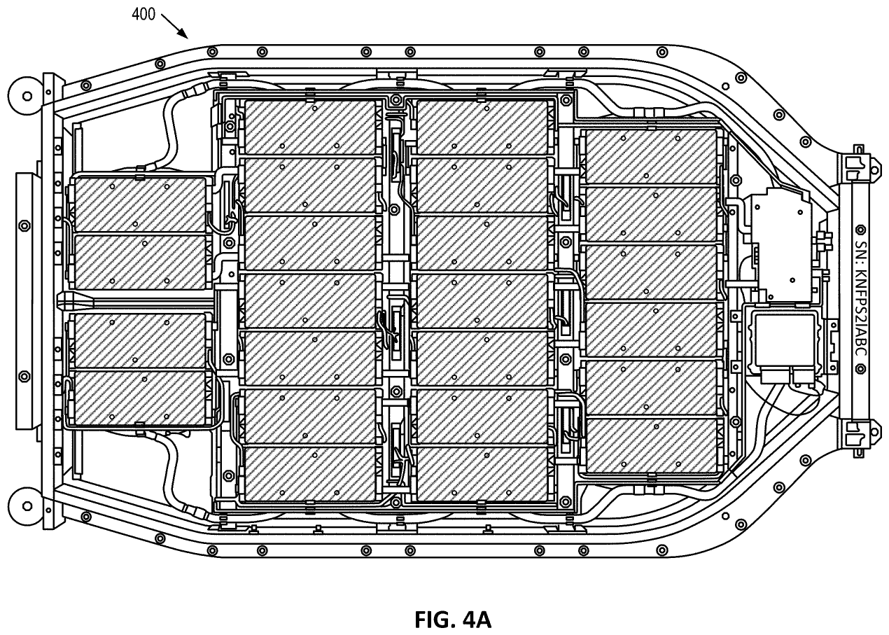

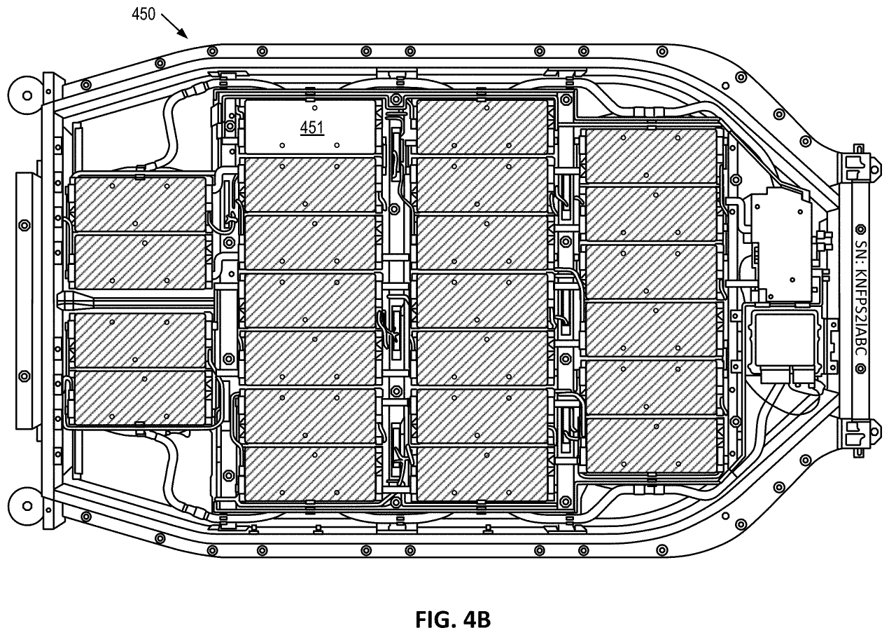

FIG. 3 is a RGB image of one embodiment of a motor vehicle battery pack. FIG. 4A is a thermal image of one embodiment of a motor vehicle battery pack. Image 300 may be an image of a battery pack for a fully electric vehicle, a partially electric (i.e., hybrid) vehicle, or a non-electric vehicle (i.e., vehicle with a traditional internal combustion engine). Furthermore, the vehicle may be one of passenger motor vehicles, sport utility vehicles (SUV), or any other wheeled vehicles such as trucks, motorcycles, buses, trains, etc. It can also be used in non-wheeled vehicles such as ships and airplanes. In fact, the illustrated embodiments can be used in any apparatus with a battery pack.

The battery pack can include a variety of components placed in a horizontal (planar) two-dimensional, or a stacked vertical configuration. Referring to FIGS. 3-4, for one embodiment, images 300/400 are for a battery pack in a two-dimensional horizontal configuration and includes battery cell modules 301, battery cell module controllers 302, high voltage plate connectors 303, low voltage connector wires 304, battery distribution unit 305, battery control module 306, coolant lines 307-308, and part identifier 309 (e.g., serial number). The cell modules 301 may include groupings of individual cell batteries. Battery cell module controllers 302 can be small PCBs that monitors temperature and voltage/current from each cell modules. High voltage plate connectors 303 can be conductor plates coupling battery cell modules together in series or parallel to achieve a desired voltage and/or current for the battery pack. High voltage plate connectors 303 may withstand 100s to 1000s of voltages. Low voltage connector wires 304 can electrically couple the cell modules 301 to cell module controllers 302. Battery distribution unit 305 can distribute power to a vehicle equipped with the battery pack to power the vehicle. Battery control module 306 can control a functionality of the battery pack. Coolant lines 307-308 can carry and circulate coolant fluids to regulate a temperature of the components of the battery pack. Part identifier 309 can be a unique identifier identifying the battery pack/assembly, such as a serial number.

For one embodiment, when a battery pack is assembled at an assembly plant, after the battery pack is assembled but before a cover is put on the battery pack, device 101 can capture one or more image profiles (e.g., RGB images and/or thermo images) for the battery pack and upload the image profiles to an image profile database on server 104 for storage. The image profiles can include a mono (such as image 300), or a left and a right RGB images for a stereo pair of images. For another embodiment, the image profiles can include one or more thermo images, such as image 400. A thermo image can be captured at an assembling phase where the battery pack is required to be charged for tested. Here, device 101 can capture a thermo/infrared image for the battery pack while it is charging or soon after it is charged, and upload the image to an image profiles database of server 104 for storage.

For one embodiment, the image profiles can be used as input datasets to train a machine learning (or Al) model to detect faulty battery pack packs. The detection can be performed at the assembly plant when the battery pack is initially assembled. The input datasets are required to be preprocessed, such as resizing the images to increase training performance, cropping portions of the images identifying any faults to improve training. For example, faulty battery packs can be marked by an annotator identifying the faults, and the types of faults for training purposes. Some examples of faults include wire disconnects, missing components, malfunctioning components, etc.

Here, the machine learning model can be a deep learning convolutional neural network (CNN) trained to detect faulty assembling of battery packs. Note, the machine learning model may include, but is not limited to, neural networks (fully connected, partially connected, or a combination thereof), support vector machines (SVM), linear regression, k-nearest neighbors, naive bayes, k-means, and random forest models. A neural network is a machine learning model which can learn to perform tasks by considering examples (e.g., training with input/output scenarios), without being programmed with any task-specific rules. A neural network is a computational approach based on a large collection of neural units or neurons in a series of hidden layers or inner layers. Each hidden layer is made up of a set of neurons, where each neuron is connected to one or more neurons in the previous layer, and where neurons in a single layer can function completely independently and may not share any connections with other neurons of the layer. A neural network is self-learning and trained, rather than explicitly programmed. A convolutional neural network (CNN) is a neural network with one or more convolutional layers. A convolutional/deconvolutional layer has each neuron connected only to a local region in the previous layer spatially, but to the full depth (i.e. all color channels for an image).

Various machine learning models can be trained by server 104 to detect faulty battery assemblies. For one embodiment, the machine learning model can be a CNN model that includes three input channels for each color (red, green, and blue) of an RGB image. For another embodiment, the CNN model can include six input channels for a stereo pair of RGB images. For another embodiment, the CNN model can include seven input channels for a stereo pair of RGB images and a grayscale thermo image channel. Here, the machine learning model(s) can be trained with one RGB image, a stereo RGB image, an electromagnetic image, and/or a thermo/infrared image.

During an assembly phase, device 101 can apply the trained AI model(s) to captured image profiles to infer a probability of a fault and the type of faults in a battery pack. If a probability is above a predetermined threshold, an alarm module of device 101 can alert an operator to manually inspect the battery pack. For one embodiment, the alarm module can halt the assembly line. For one embodiment, the inference further provides the types and locations of the faults and this information can be communicated to the operator through visual or audio, e.g., a display/speaker.

When a need arises to diagnose a health of the battery pack at some later time, e.g., when the vehicle with the battery pack is at a repair shop/garage, a battery diagnostics device (such as device 102 of FIG. 1) can capture an image of a battery pack for analysis. For one embodiment, battery diagnostics device 102 captures a thermo image with a top-down view of the battery pack. For one embodiment, the thermo image is captured with the battery pack with or without a cover. Because the battery pack includes cell modules laid in a flat planar arrangement, the top-down thermo image can capture all or most of the components of the battery pack. In some embodiments, the battery pack thermo image is captured in an angle or on a side depending on the battery components arrangements, e.g., the components may be stacked vertically, etc.

For one embodiment, device 102 obtains part identifier 309 for the battery pack based on an image recognition algorithm. Device 102 then queries server 104 based on identifier 309 to retrieve a set of images (or image profiles) previously captured for the battery pack. Based on the captured images, device 102 compares the currently captured images to previously captured images for the same or similar (e.g., similar battery pack layout, vehicle make, vehicle model) battery pack to analyze the images for any discrepancies.

For one embodiment, an image recognition algorithm can compare the images for discrepancies in hot spots or cold spots. An analyzer than analyzes the discrepancies. For one embodiment, if a new hot spot is detected, there may be an overheated or malfunctioning component. For one embodiment, a new cold spot may indicate a component not working or not working efficiently.

FIG. 4B is a thermal image of one embodiment of a motor vehicle battery pack with a problematic cell module 451. Referring to FIG. 4B, device 102 may apply a diagnostics algorithm to image 450 (e.g., comparing current image with previously captured thermo images or applying an AI model to image 450) to determine a discrepancy exists, e.g., a new cold spot is detected near cell module 451. Image 450 can be captured with or without the battery cover on the battery pack. Here, the new cold spot can indicate a malfunctioning battery cell module 451. For one embodiment, if there is no discrepancy detected for the thermal image, then the battery pack can be deemed healthy (with or without removing a cover of the battery pack/assembly). If there is one or more discrepancies, device 102 may prompt an operator/technician to remove the cover of the battery pack for further inspection. In another embodiment, an electromagnetic image can be captured and compared for discrepancies, in substitution, or in additional to comparing thermal images.

Upon removal of a battery cover for battery pack, for one embodiment, one or more RGB images can be captured for the battery pack. Based on the RGB images, an image recognition algorithm or AI model of device 102 can compare the current RGB images and the previously captured RGB images for abnormalities such as white deposit, which likely indicates a malfunctioning component; or dark spots, which likely indicates overheating of a component. For another embodiment, the image recognition algorithm or AI model can compare the images for liquid such as coolant leakages.

For one embodiment, device 102 can retrieve one or more AI models trained to analyze the image profiles for any of the abnormalities/discrepancies as discussed above. For one embodiment, each AI model can correspond to a vehicle model or vehicle manufacturer since each vehicle model can have a different image profile.

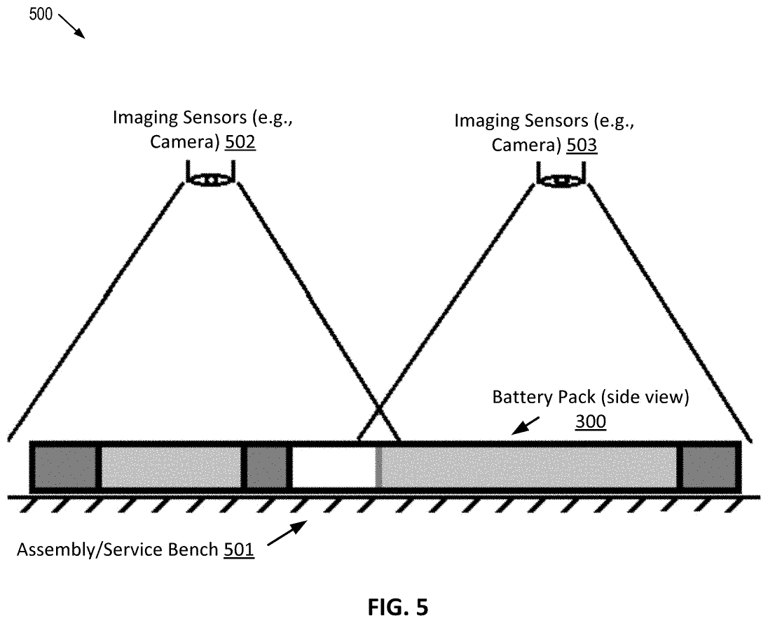

FIG. 5 is a side view of one embodiment of an assembly/service bench setup. Referring to FIG. 5, assembly/service bench setup 500 can be a bench setup at an assembly plant or a service outlet where a battery pack for a vehicle can be assembled/serviced/diagnosed. Setup 500 includes an assembly/service bench 501, and imaging sensors 502-503 positioned a distance above bench 501. The imaging sensors 502-503 can be any types of imaging sensors, e.g., RGB, infrared, electromagnetic (mono or stereo) imaging sensors, or a combination thereof. Imaging sensors 502-503 can be positioned above bench 501 to capture one or more images of a battery pack 300. In one embodiment, imaging sensors 502-503 may be mounted to a post/frame or a ceiling portion of bench setup 500, where image sensors 502 is to capture a left portion of battery pack, and imaging sensors 503 is to capture a right portion of battery pack. Battery pack 300 may be place horizontally on bench 501, or in any manner for imaging sensors 502-503 to capture one or more image profiles of battery pack 300. In another embodiment, imaging sensors 502-503 captures stereo images with depth information for battery pack 300. In another embodiment, imaging sensors 502-503 captures electromagnetic imaging information for battery pack 300.

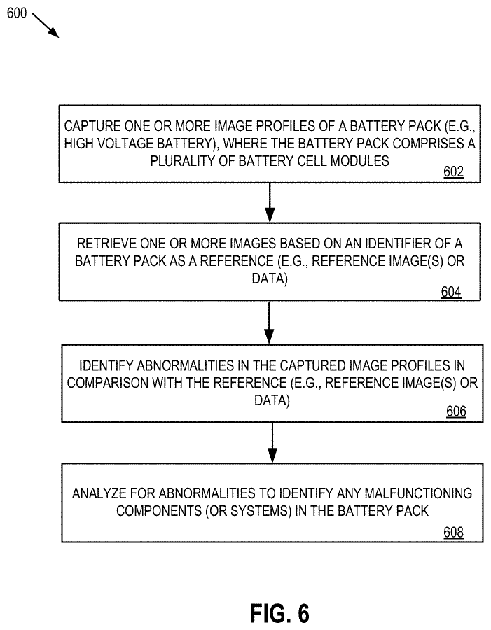

FIG. 6 is a flow diagram of one embodiment of a method for battery pack assembly/diagnostics. Method 600 is performed by processing logic that may comprise hardware (circuitry, dedicated logic, etc.), software, firmware, or a combination. For one embodiment, method 600 is performed by a battery diagnostics device, such as devices 101-102 of FIG. 1.

Referring to FIG. 6, at processing block 602, processing logic captures one or more image profiles of the battery pack, where the battery pack includes a number of battery cell modules. At processing block 604, processing logic retrieves one or more image profiles based on an identifier of the battery pack, wherein the one or more image profiles was previously captured for the battery pack. At processing block 606, processing logic identifies abnormalities for the captured image profiles in comparison with the retrieved one or more image profiles. At processing block 608, processing logic analyzes for abnormalities to identify any malfunctioning components (or subsystems or systems) of the battery pack.

For one embodiment, the one or more image profiles comprises a thermal image, and the thermal image is captured while charging or subsequent to charging the battery pack. For another embodiment, the thermal image is captured without unsecuring a cover of the battery pack.

For another embodiment, processing logic further determines an abnormality to be a cold spot, where the cold spot is not present in the thermal image previously captured and the cold spot is likely to indicate a component that is not working or is not working efficiently. For another embodiment, processing logic further determines an abnormality to be a hot spot, where the hot spot is not present in the thermal image previously captured and the hot spot is likely to indicate a component is overheating or malfunctioning. For another embodiment, processing logic further identifies the component to be a battery cell module, a power distribution unit, a controller, or an electrical wire/bar.

For one embodiment, the one or more image profiles are captured in a top-down view showing a planar view of the battery pack. For one embodiment, the one or more image profiles includes a left and a right red-green-blue (RGB) image to form a stereo image set, where the stereo image set includes depth information identifying a depth of the components of the battery pack.

For another embodiment, processing logic further determines an abnormality to be a white deposit, where a white deposit indicates likely damage to a battery cell module. For another embodiment, processing logic further determines an abnormality to be a dark spot on a wire terminal, where a dark spot indicates likely damage to a terminal from overheating.

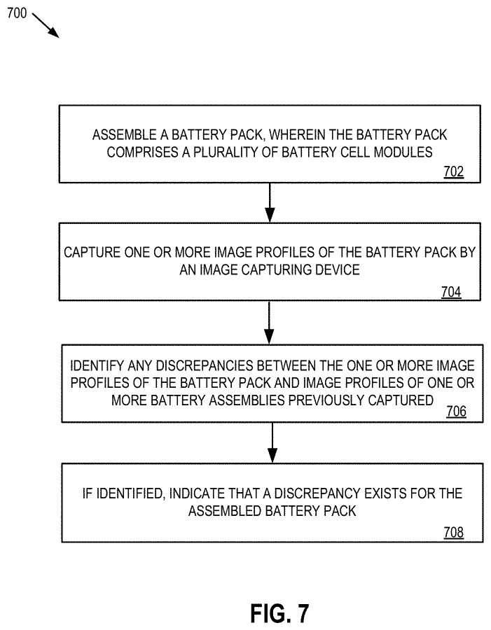

FIG. 7 is a flow diagram of one embodiment of a method to assemble a battery pack. Method 700 is performed by processing logic that may comprise hardware (circuitry, dedicated logic, etc.), software, firmware, or a combination. For one embodiment, method 700 is performed by a battery diagnostics device, such as devices 101-102 of FIG. 1.

Referring to FIG. 7, at processing block 702, processing logic assembles a battery pack, where the battery pack comprises a number of battery cell modules. At processing block 704, processing logic captures one or more image profiles of the battery pack by an image capturing device. At processing block 706, processing logic identifies for any discrepancies between the one or more image profiles of the battery pack and image profiles of one or more battery assemblies previously captured. At processing block 708, if identified, processing logic indicates that a discrepancy exists for the assembled battery pack.

For one embodiment, the one or more image profiles are captured after the battery pack is assembled and before a cover is put on the battery pack. For one embodiment, identifying any discrepancies between the one or more image profiles of the battery pack and images of one or more battery assemblies previously captured includes applying an AI model to the one or more image profiles of the battery pack to identify any discrepancies, where the AI model is trained with images of other battery assemblies to identify discrepancies between an incomplete and a complete battery pack.

For one embodiment, processing logic further halts an assembly line for the assembled battery pack for an operator to diagnose a discrepancy. For one embodiment, processing logic further sets an alarm to notify an operator to inspect for a discrepancy of the assembled battery pack.

The embodiments as will be hereinafter described may be implemented through the execution of instructions, for example as stored in memory or other element, by processor(s) and/or other circuity of battery diagnostics devices 101-102. Particularly, circuitry of devices 101-102, including but not limited to processor(s) 212 may operate under the control of a program, routine, or the execution of instructions to execute methods or processes in accordance with the aspects and features described herein. For example, such a program may be implemented in firmware or software (e.g. stored in memory 205) and may be implemented by processors, such as processor(s) 212, and/or other circuitry. Further, the terms processor, microprocessor, circuitry, controller, etc., may refer to any type of logic or circuitry capable of executing logic, commands, instructions, software, firmware, functionality and the like.

Further, some or all of the functions, engines, or modules described herein may be performed by devices 101-102 themselves and/or some or all of the functions, engines or modules described herein may be performed by another system (e.g., server 104) connected through network interface 103 to devices 101-102. Thus, some and/or all of the functions may be performed by another system, and the results or intermediate calculations may be transferred back to devices 101-102.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in various ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

For one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable one to make or use the methods, systems, and apparatus of the present disclosure. Various modifications to these embodiments will be readily apparent, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method to diagnose a battery pack for a vehicle, the method comprising:
capturing one or more image profiles of the battery pack, wherein the battery pack comprises a plurality of battery cell modules;
retrieving one or more image profiles based on an identifier of the battery pack, wherein the one or more image profiles was previously captured for a battery pack as a reference;
identifying abnormalities for the captured images in comparison with the reference; and
analyzing for abnormalities to identify any malfunctioning components in the battery pack.

2. The method of claim 1, wherein the one or more image profiles comprises a thermal image, and the thermal image is captured while charging or subsequent to charging the battery pack.

3. The method of claim 2, wherein the thermal image is captured without unsecuring a cover of the battery pack.

4. The method of claim 2, further comprising: determining an abnormality to be a cold spot, wherein the cold spot is not present in the thermal image previously captured and the cold spot is likely to indicate a component that is not working or is not working efficiently.

5. The method of claim 2, further comprising: determining an abnormality to be a hot spot, wherein the hot spot is not present in the thermal image previously captured and the hot spot is likely to indicate a component is overheating or malfunctioning.

6. The method of claim 5, further comprising: identifying the component to be a battery cell module, a power distribution unit, a controller, or an electrical wire/bar.

7. The method of claim 1, wherein the one or more image profiles are captured in a top-down view showing a planar view of the battery pack.

8. The method of claim 1, wherein the one or more image profiles comprises a left and a right red-green-blue (RGB) image to form a stereo image set, wherein the stereo image set includes depth information identifying a depth of the components of the battery pack.

9. The method of claim 8, further comprising: determining an abnormality to be a white deposit, wherein a white deposit indicates likely damage to a battery cell module.

10. The method of claim 8, further comprising: determining an abnormality to be a dark spot on a wire terminal, wherein a dark spot indicates likely damage to a terminal from overheating.

11. A method to assemble a battery pack, the method comprising:
assembling a battery pack, wherein the battery pack comprises a plurality of battery cell modules;
capturing one or more image profiles of the battery pack by an image capturing device;
identifying any discrepancies between the one or more image profiles of the battery pack and image profiles of one or more battery assemblies previously captured; and
if identified, indicating that a discrepancy exists for the assembled battery pack.

12. The method of claim 11, wherein the one or more image profiles are captured after the battery pack is assembled and before a cover is put on the battery pack.

13. The method of claim 11, wherein identifying any discrepancies between the one or more image profiles of the battery pack and image profiles of one or more battery assemblies previously captured comprises: applying an AI model to the one or more image profiles of the battery pack to identify any discrepancies, wherein the AI model is trained with image profiles of other battery assemblies to identify discrepancies between an incomplete and a complete battery pack.

14. The method of claim 11, further comprising: halting an assembly line for the assembled battery pack for an operator to diagnose a discrepancy.

15. The method of claim 11, further comprising: setting an alarm to notify an operator to inspect for a discrepancy of the assembled battery pack.

16. An apparatus to diagnose a battery pack for a vehicle, the apparatus comprising:
one or more processors;
a memory coupled to the one or more processors, the memory storing instructions which, when executed by the one or more processors, cause the one or more processors to perform operations, the operations comprising:
capturing one or more image profiles of the battery pack, wherein the battery pack comprises a plurality of battery cell modules;
retrieving one or more image profiles based on an identifier of the battery pack, wherein the one or more image profiles was previously captured for the battery pack;
identifying abnormalities for the captured image profiles in comparison with the retrieved one or more image profiles; and
analyzing for abnormalities to identify any malfunctioning components in the battery pack.

17. The apparatus of claim 16, wherein the one or more image profiles comprises a thermal image, and the thermal image is captured while charging or subsequent to charging the battery pack.

18. The apparatus of claim 17, wherein the thermal image is captured without unsecuring a cover of the battery pack.

19. The apparatus of claim 18, wherein the operations further comprise: determining an abnormality to be a cold spot, wherein the cold spot is not present in the thermal image previously captured and the cold spot is likely to indicate a component that is not working or is not working efficiently.

20. The apparatus of claim 17, wherein the operations further comprise: determining an abnormality to be a hot spot, wherein the hot spot is not present in the thermal image previously captured and the hot spot is likely to indicate a component is overheating or malfunctioning.
